(19) United States
(12) Patent Application Publication
(10) Pub. No.: US 2021/0116582 A1
(43) Pub. Date: Apr. 22, 2021

(54) METHOD AND SYSTEM FOR ESTIMATING A WAIT TIME AT A DESTINATION OF A VEHICLE USING V2V COMMUNICATION

(71) Applicants: HYUNDAI MOTOR COMPANY, Seoul (KR); KIA MOTORS CORPORATION, Seoul (KR)

(72) Inventor: Margaux Krause, Pinckney, MI (US)

(73) Assignees: HYUNDAI MOTOR COMPANY, Seoul (KR); KIA MOTORS CORPORATION, Seoul (KR)

(21) Appl. No.: 16/659,235

(22) Filed: Oct. 21, 2019

(51) Int. Cl. G01S 19/51; G07C 5/08; G06N 5/04; G06N 7/00; H04W 4/46; G01C 21/36

(52) U.S. Cl. CPC G01S 19/51; G07C 5/085; G01C 21/3691; G06N 7/005; H04W 4/46; G06N 5/04

(57) ABSTRACT

A method and system for estimating a wait time at a destination of a vehicle using a V2V communication are provided. The method may include: receiving, by a user interface, a request from a user to estimate the wait time at the destination of the vehicle; determining, by a Global Positioning System (GPS) navigation unit, the destination of the vehicle, a distance from a current location of the vehicle to the destination, and an estimated arrival time of the vehicle at the destination; collecting, by the communicator, first information from near-by vehicles using a vehicle-to-vehicle (V2V) communication; calculating, by a controller, a number of target vehicles based on second information received from the near-by vehicles; and estimating, by the controller, the wait time at the destination based on the calculated number of the target vehicles.

### TECHNICAL FIELD

The present disclosure relates to systems and methods for estimating a wait time at a destination of a vehicle using a vehicle-to-vehicle (V2V) communication.

### BACKGROUND

The statements in this section merely provide background information related to the present disclosure and may not constitute prior art.

As navigation apps (i.e., Google Maps, Apple Maps, Waze, etc.) are widely used when driving a vehicle to search for a destination or to find the best route to the destination, predicting an estimated time of arrival becomes an essential feature of the navigation apps.

Recently, many drivers rely on the navigation apps embedded in smart phones, most of which use the smartphone's Global Positioning System (GPS) to estimate the time of arrival at the destination, and some of these navigation apps are processed based on historic records or past data. As a result of relying solely on the historic records or the past data without considering traffic conditions in real time, the navigation apps may not provide an accurate prediction of an arrival time. Accordingly, more advanced technologies may be desirable in order to provide a driver with a more accurate estimation of the arrival time at the destination.

### SUMMARY

As more vehicles are equipped with the V2V communication devices, estimating the wait time at the destination on a real-time basis may be feasible by using the V2V communication devices. In addition, various types of information that would be helpful to estimate the wait time at the destination may be accessible when the vehicles communicate through the V2V communication devices. In addition, data analytics make it possible to predict a traffic congested area or the wait time at a desired destination more accurately.

As connected cars become more numerous, the demand for accurately estimating the wait time at the destination has increased. Unlike the conventional technologies using the navigation apps or software to estimate travel time based on traffic conditions, a specific time of day, or the like, the present disclosure factors in moving vehicles as well as the vehicles approaching from different directions with the V2V communication when calculating the estimated wait time at the destination. As such, the present disclosure ensures to accurately estimate the wait time at the destination by calculating the future wait time based on various information received from the V2V communication devices.

In one aspect of the present disclosure, a method for estimating a wait time at a destination of a vehicle is provided. The method may include receiving, by a user interface, a request from a user to estimate the wait time at the destination of the vehicle; determining, by a Global Positioning System (GPS) navigation unit, the destination of the vehicle, a distance from a current location of the vehicle to the destination, and an estimated arrival time of the vehicle at the destination; collecting, by a communicator, first information from near-by vehicles using a vehicle-to-vehicle (V2V) communication, wherein the near-by vehicles are located within a predetermined distance from the destination; calculating, by a controller, a number of target vehicles based on second information received from the near-by vehicles, wherein each of the target vehicles is expected to arrive at the destination within a predetermined time period of the estimated arrival time; and estimating, by the controller, the wait time at the destination based on the calculated number of the target vehicles. Here, the first information may include a speed of the near-by vehicles, a direction of the near-by vehicles, a drive gear of the near-by vehicles, and a number of passengers in the near-by vehicles. The second information may include a parking duration of the near-by vehicles, an operation status of the near-by vehicles, and an amount of fuel that the near-by vehicles maintain.

The method may further include displaying, by the controller, the estimated wait time at the destination on the user interface.

The method may further include determining whether the near-by vehicle are in a parking status or a driving status based on the first information; and excluding a number of non-target vehicles from a number of near-by vehicles at least one of when the non-target vehicles are parked longer than a predetermined amount of time, when the non-target vehicles are out of operation, or when the non-target vehicles do not maintain a predetermined amount of fuel to arrive at the destination.

The method may further include calculating a first probability that the near-by vehicles in the parking status are located at the destination based on at least one of the parking duration of the near-by vehicles, an availability of a remote start of the near-by vehicles, or a proximity of key fobs.

The method may further include calculating a second probability that the near-by vehicles in the driving status arrive at the destination based on at least one of the speed of the near-by vehicles, the direction of the near-by vehicles, or navigation parameters of the near-by vehicles.

The method may further include determining a first value based on the number of near-by vehicles in the parking status and the first probability; determining a second value based on the number of near-by vehicles in the driving status and the second probability; and calculating the number of target vehicles by adding the first value to the second value.

The method may further include estimating the wait time at the destination based on the calculated number of target vehicles and an average time per a vehicle spent at the destination.

In some forms of the present disclosure, collecting information from the near-by vehicles may be performed by a route factoring scheme.

In some forms of the present disclosure, collecting information from the near-by vehicles may also be performed by using mesh network communication.

In another aspect of the present disclosure, a system for estimating a wait time at a destination of a vehicle is provided. The system may include a Global Positioning System (GPS) navigation unit configured to determine a route to the destination, a distance from a current location of the vehicle to the destination, and an estimated arrival time of the vehicle at the destination; a communicator configured to communicate with near-by vehicles via a vehicle-to-vehicle (V2V) communication, wherein the near-by vehicles are located within a predetermined distance from the destination; and to collect information from the near-by vehicles; and a controller configured to calculate a number of target vehicles based on the collected information from the near-by vehicles, wherein each of the target vehicles is expected to arrive at the destination within a predetermined time period of the estimated arrival time; and to estimate the wait time at the destination based on the calculated number of target vehicles. Here, the information may include a first set of the information including at least one of a speed of the near-by vehicles, a direction of the near-by vehicles, a drive gear of the near-by vehicles, or a number of passengers in the near-by vehicles; and a second set of the information including at least one of a parking duration of the near-by vehicles, an operation status of the near-by vehicles, or an amount of fuel that the near-by vehicles maintain.

The system may further include a user interface configured to receive, from a user, a request to estimate the wait time at the destination; and display the estimated wait time at the destination.

The controller may be configured to determine whether the near-by vehicles are in a parking status or a driving status based on the first set of the information; and to exclude a number of non-target vehicles from a number of near-by vehicles at least one of when the non-target vehicles are parked longer than a predetermined amount of time, when the non-target vehicles are out of operation, or when the non-target vehicles do not maintain a predetermined amount of fuel to arrive at the destination.

The controller may be further configured to calculate a first probability that the near-by vehicles in the parking status are located at the destination based on at least one of the parking duration of the near-by vehicles, an availability of a remote start of the near-by vehicles, or a proximity of key fobs.

The controller may be further configured to calculate a second probability that the near-by vehicles in the driving status arrive at the destination based on at least one of the speed of the near-by vehicles, the direction of the near-by vehicles, or navigation parameters of the near-by vehicles.

The controller may be further configured to determine a first value based on the number of near-by vehicles in the parking status and the first probability; to determine a second value based on the number of near-by vehicles in the driving status and the second probability; and to calculate the number of target vehicles by adding the first value to the second value.

The controller may be configured to estimate the wait time at the destination based on the calculated number of target vehicles and an average time per a vehicle spent at the destination.

In some forms of the present disclosure, the communicator may be configured to collect the information from the near-by vehicles using a route factoring scheme.

In some forms of the present disclosure, the communicator may also be configured to collect the information from the near-by vehicles via mesh network communication.

The method and system for estimating the wait time at the destination of the vehicle using the V2V communication described herein may be more accurate, compared to conventional technologies using historic records, to estimate the wait time because the prediction is based on real-time V2V data or information. In addition, the amount of information obtainable from the V2V communication may be increased even more when more vehicles install the V2V communication devices.

The wait time estimate feature using the V2V communication may help drivers to see their total travel time from a starting point to an ending point. It will assist them to manage their personal schedule depending on the estimated wait time. For example, the driver may change a destination if the wait time at a desired destination is shown to be higher than usual, thereby avoiding the congested area and saving time.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram showing key components implemented in a vehicle in one form of the present disclosure;

FIG. 2 is a flowchart describing steps of a method for estimating the wait time at the destination of the vehicle in one form of the present disclosure;

FIG. 3A is a diagram illustrating an estimation of total vehicles at the destination based on vehicle distance in one form of the present disclosure;

FIG. 3B is a diagram illustrating an estimation of the wait time at the destination based on a total number of other vehicles with probability of visiting the destination in one form of the present disclosure;

FIG. 4 is a diagram illustrating an estimation of the wait time at the destination based on route factoring in one form of the present disclosure; and

FIG. 5 is a diagram illustrating an estimation of the wait time at the destination based on mesh network communication between vehicles in one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Throughout this specification and the claims which follow, unless explicitly described to the contrary, the word “comprise” and variations such as “comprises” or “comprising” will be understood to imply the inclusion of stated elements but not the exclusion of any other elements.

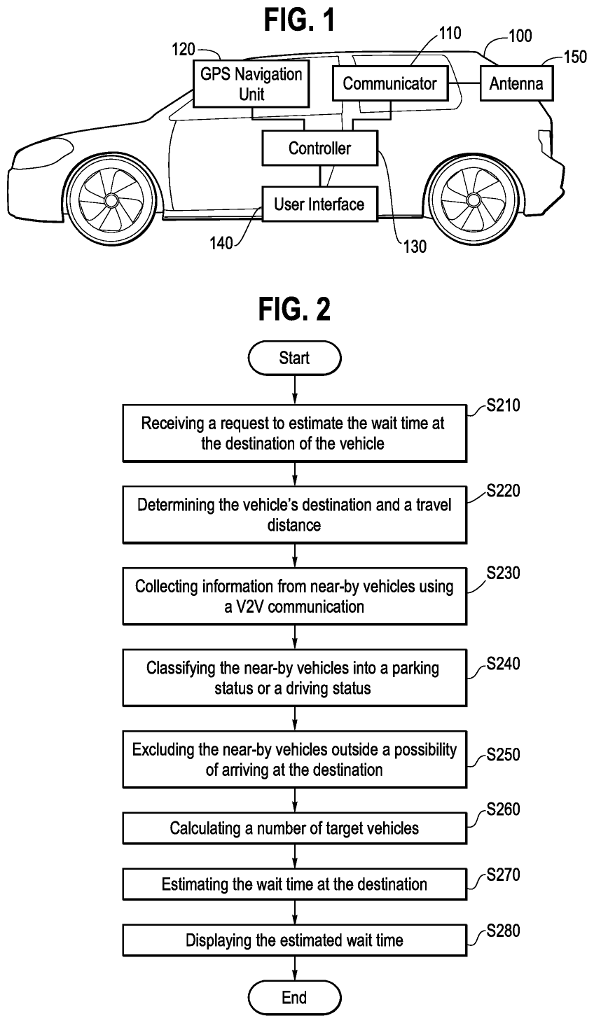

FIG. 1 is a block diagram showing key components implemented in a vehicle in some forms of the present disclosure.

A communicator 110 mainly collects information through its antenna 150 (e.g. V2V communication antenna) from near-by vehicles that are located within a predetermined distance from the destination to predict whether the near-by vehicles are to be arrived at the destination. The information collected from the near-by vehicles may include a speed of the near-by vehicles, a direction of the near-by vehicles, a drive gear of the near-by vehicles, and a number of passengers in the near-by vehicles. Also, the communicator 110 transmits information regarding statuses of the near-by vehicles to the controller 130. The communicator 110 may be a vehicle-to-vehicle (V2V) communication device, Dedicated Short Range Communications (DSRC) device, cellular device, or any similar communication device. Alternatively, the V2V communication device may be used together with or replaced by a vehicle-to-infrastructure (V2I) communication device or a cloud communication device.

The GPS navigation unit 120 finds a route to the destination and an approximate travel distance from a current location of the vehicle 100 to the destination, and an estimated arrival time of the vehicle 100 at the destination when the user interface 140 transmits a request from a user of the vehicle 100 to estimate the wait time at the destination. The GPS navigation unit 120 may be housed on-board the vehicle (embedded vehicle unit) or referenced off-board (server-based). The GPS navigation unit 120 may also be housed in a vehicle accessory (e.g. dedicated GPS navigation devices) or smartphone device.

The controller 130 receives and transmits information to the other components in the vehicle 100 (e.g. GPS navigation unit 120, communicator 110, user interface 140). For example, the controller 130 receives a request from a user interface 140 to estimate the wait time at a selected destination. The controller 130 then transmits this destination request to the GPS navigation unit 120 to receive back from the GPS navigation unit 120 the estimated time of arrival. The controller 130 also transmits the destination request to the communicator 110 to receive back information about near-by vehicles (e.g. parking duration of the near-by vehicles, an operation status of the near-by vehicles, and an amount of fuel that the near-by vehicles maintain). Using the received information, the controller 130 calculates a number of target vehicles that will be arriving at the destination within a predetermined time period of the estimated arrival time. Once the controller 130 calculates the number of target vehicles, the controller 130 calculates the wait time at the destination based on the calculated number of target vehicles and an average time spent by a vehicle at the destination. Finally, the controller 130 transmits to the user interface 140 the estimated wait time that was calculated.

The term controller 130 refers to a hardware device that includes a memory and a processor configured to execute one or more steps. The memory is configured to store algorithmic steps and the processor is specifically configured to execute the algorithmic steps to perform one or more processes which are described further below.

Furthermore, the processor executing the algorithmic steps may be embodied as non-transitory computer readable media on a computer readable medium containing executable program instructions executed by a processor, a controller, or the like. Examples of computer readable media include, but are not limited to, ROM, RAM, compact disc (CD) ROMs, magnetic tapes, floppy disks, flash drives, smart cards, and optical data storage devices. The computer readable recording medium can also be distributed in network coupled computer systems so that the computer readable media are stored and executed in a distributed fashion.

The user interface 140 receives an input from a user of the vehicle 100 who requests to estimate the wait time at the destination. After the controller 130 completes calculating the wait time at the destination, the user interface 140 displays and/or outputs the wait time. The user interface 140 may be any type of visual displays where the wait time can be provided to the user. Also, if the vehicle 100 is equipped with voice recognition technology, the user interface 140 may be any type of audio inputs and outputs where the wait time can be provided to the user in an audio format. In some implementations, the user interface 140 may additionally implement artificial intelligence for the vehicle 100 to select the destination or database of preselected routes (e.g. delivery truck).

FIG. 2 is a flowchart describing steps of a method for estimating the wait time at the destination of the vehicle 100 in one form of the present disclosure. Each step of estimating the wait time at the destination will be explained in detail.

A request to estimate the wait time at the destination is received by the controller 130 via the user interface 140 (S210). The request can be input to the user interface 140 based on a direct user input (e.g. microphone, touchscreen, keyboard, audio, and etc.), or indirect user input (e.g. occupants conversation, internet search, driving history, and etc.).

When the request to estimate the wait time at the destination is received, the GPS navigation unit 120 determines the destination of the vehicle 100, a distance from a current location of the vehicle 100 to the destination, and an estimated arrival time of the vehicle 100 at the destination (S220). The distance is calculated by the GPS navigation unit 120 on or off-board in the vehicle 100 and can be measured in time, miles, kilometers, or the like.

Then, the controller 130 controls the communicator 110 to establish a V2V communication with the near-by vehicles using the antenna 150 and the communicator 110 collects information from the near-by vehicles (S230). For example, the controller 130 determines which near-by vehicles could arrive at the destination before the vehicle 100 based on the near-by vehicle's GPS location, strength of V2V communication signal, and so forth. The communicator 110 may also collect other information from the near-by vehicles such as speed, direction, drive gear, and a number of passengers in the near-by vehicles. In some forms of the present disclosure, the communicator 110 may collect additional information such as a fuel/charge level, navigation details (e.g., destination, route, past locations visited), engine/coolant temperature, remote start status, proximity of key, camera data, service/warning status, and Advanced Driver-Assistance Systems (ADAS) parking sensor status.

The controller 130 uses each of the near-by vehicles' information to determine whether each of the near-by vehicles is in a parking status or a driving status (S240). Specifically, the controller 130 may determine that the near-by vehicle is parked if the speed of the near-by vehicle is zero, the GPS navigation unit 120 indicates that the near-by vehicle is located in a parking lot, and/or the driving gear of the near-by vehicle is P (parking). On the other hand, the controller 130 may determine that the near-by vehicle is in the driving status if the speed of the near-by vehicle is greater than zero, the driving gear of the near-by vehicle is D (driving), and/or the GPS navigation unit 120 indicates that the near-by vehicle is not located in a parking lot.

Next, the controller 130 filters out any near-by vehicles unlikely to arrive at the destination based on some indications (S250) such as (i) the near-by vehicle is parked longer than a typical length of stay, (ii) the near-by vehicle is out of operation, and/or (iii) the near-by vehicle does not have enough gas to arrive at the destination. The parked near-by vehicles may still be able to communicate with the vehicle 100 via auxiliary power-based telematics which would enable the implementation of V2V communication. In some forms of the present disclosure, the step of filtering out (S250) may occur prior to the step of classifying the near-by vehicles into the parking status or the driving status (S240).

In S260, the controller 130 in the vehicle 100 calculates a number of target vehicles by running an algorithm to predict the number of target vehicles being present at the destination. The target vehicles here refer to vehicles that are already located and/or are likely to arrive at the destination within a predetermined time period of the estimated arrival time.

One example of an algorithm or formula used in S260 will be explained.

The number of target vehicles=(the number of near-by vehicles in the parking status*P1)+(the number of near-by vehicles in the driving status*P2).

Here, P1 is the probability of the parked near-by vehicles that are likely to be located within the destination and P2 is the probability of the driving near-by vehicles that are likely to arrive at the destination within the predetermined time period of the estimated arrival time of the vehicle 100. P1 is based on the information received via the communicator 110 such as a parking duration of the near-by vehicles, an availability of a remote start of the near-by vehicles, a proximity of key fobs, and so forth. Similarly, P2 is based on the information received via the communicator 110 such as the speed of the near-by vehicles, the direction of the near-by vehicles, navigation parameters, and so forth.

In S270, the controller 130 estimates the wait time at the destination at the estimated arrival time of the vehicle 100. Specifically, it multiplies the number of target vehicles by an average time spent per a vehicle at the destination. The average time spent per a vehicle or a person at the destination may be obtained through a database (e.g. Google Maps, Yelp). Also, more specific wait times per a person may be obtained from the destination itself including restrictions on number of the vehicles or persons allowed. Here, the wait time may be specific (i.e., 1 hour) or a range of time (i.e., 20-40 minutes). As such, the wait time may be calculated using the following equation.

The estimated wait time is equal to the number of target vehicles multiplied by an average time spent per a vehicle at the destination. This equation may be suitable for any vehicle-based services such as gas station, drive-thru food service, and so forth.

In some forms of the present disclosure, more accurate wait time may be calculated using the following equation.

The estimated wait time is equal to the number of passengers in the near-by vehicles multiplied by an average wait time per a person at the destination. This equation may be applied for any destination where passengers typically exit the vehicle to receive services. In this case, it may be more accurate to consider a total number of passengers in the near-by vehicles. For example, an industry average number of passengers (1-2 passengers per vehicle) may be applied or an actual number of passengers in the near-by vehicles may be collected by the communicator 110.

In S280, the controller 130 transmits the estimated wait time to the user interface 140. The user then receives the estimated wait time through the user interface 140.

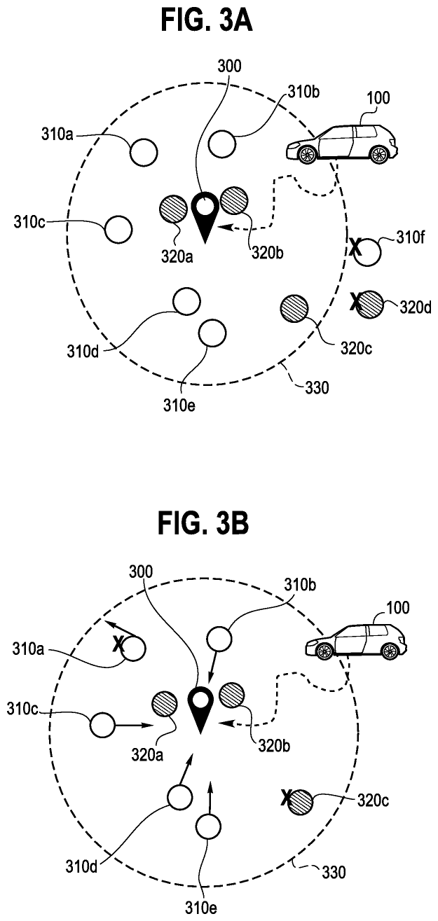

FIG. 3A is a diagram illustrating an estimation of total vehicles at the destination based on vehicle distance in some forms of the present disclosure.

In S240, the controller 130 classifies the near-by vehicles into the parking status 320 and the driving status 310. In FIG. 3A, the near-by vehicles in the parking status 320 are indicated as 320a, 320b, 320c, and 320d, respectively. Similarly, the near-by vehicles in the driving status 310 are indicated as 310a, 310b, 310c, 310d, 310e, and 310f, respectively. The near-by vehicles may be divided into two groups—inside a distance range 330 and outside the distance range 330—based on the speed of the near-by vehicles, the driving gear of the near-by vehicles, and the location of the near-by vehicles.

In FIG. 3A, the near-by vehicles 310f and 320d are shown to be excluded in accordance with S250. Specifically, the distance range 330 indicates that, if the near-by vehicles 310 and 320 are located inside the distance range 330, they are more likely to arrive at the destination 300 at the same time as the vehicle 100. This distance range 330 is comparable to the distance between the current location of the vehicle 100 and the selected destination (i.e., destination 300), as determined by the GPS navigation unit 120. Here, the near-by vehicles in the driving status 310a, 310b, 310c, 310d, 310e as well as the near-by vehicles in the parking status 320a, 320b, 320c are said to be located within the distance range 330. Conversely, if the near-by vehicles 310 and 320 are located outside the distance range 330, they are less likely to arrive at the destination 300 at the same time as the vehicle 100. In FIG. 3A, the near-by vehicles, specifically 310f and 320d, are illustrated to be located outside the distance range 330. Accordingly, the near-by vehicles that are located outside the distance range 330, specifically 310f and 320d, will be excluded when calculating the number of target vehicles.

FIG. 3B is a diagram illustrating an estimation of the wait time at the destination 300 based on a total number of other vehicles with probability of visiting the destination 300 in some forms of the present disclosure. In FIG. 3B, among the driving near-by vehicles 310, 310b, 310c, 310d, and 310e are all indicated as driving in a direction toward the destination 300. Accordingly, one of the near-by vehicles in the driving status 310a which is going in an opposite direction of the destination 300 is filtered out. Similarly, among the parked near-by vehicles 320, one of the near-by vehicles in the parking status 320c is excluded because (i) one of the near-by vehicles in the parking status 320c may be parked longer than a typical stay, (ii) one of the near-by vehicles in the parking status 320c may be out of operation, and/or (iii) one of the near-by vehicles in the parking status 320c may not have a sufficient amount of gas to arrive at the destination 300. As such, one of the near-by vehicles in the parking status 320c may be excluded.

In FIG. 3B, the number of target vehicles may be calculated as follows:

the number of target vehicles=the number of the parked near-by vehicles 320 (in this case, 320a and 320b)*P1+the number of the driving near-by vehicles 310 (in this case, 310b, 310c, 310d, and 310e)*P2, where P1 is the probability of the parked near-by vehicles 320 that are likely to be located within the destination 300 and P2 is the probability of the driving near-by vehicles 310 that are likely to arrive at the destination 300. P1 is based on the information received via the communicator 110 such as a parking duration of the near-by vehicles, an availability of a remote start of the near-by vehicles, a proximity of key fobs, and so forth. Similarly, P2 is based on the information received via the communicator 110 such as the speed of the near-by vehicles, the direction of the near-by vehicles, navigation parameters of the near-by vehicles, and so forth.

# of vehicles=V*Q (0)

# of vehicles=X*P+Y*R (1)

# of vehicles or occupants=Σₓ₌₀ⁿƒₓ*pₓ+Σ_{y=0}ⁿƒ_{y}*r_{y} (2)

In some forms of the present disclosure, when calculating the number of target vehicles, different types of equations may be used. In a sample equation above (0), the number of target vehicles may be calculated by multiplying V and Q, where V is the number of near-by vehicles near the destination 300, and Q is a constant for the probability that the near-by vehicles would go to the destination 300 based on the popularity of the destination 300.

In another basic equation above (1), the number of target vehicles may be calculated based on the unique probabilities for the parked near-by vehicles 320 and the driving near-by vehicles 310, respectively, to select the same destination 300 as the vehicle 100. The position and classification of whether the near-by vehicle is in the parking or driving status are based on the information received via the communicator 110.

As discussed in S260, X is the number of the parked near-by vehicles 320 near the destination 300 and P is an average probability that the parked near-by vehicles 320 would remain at the destination 300 before the vehicle 100 arrives. Similarly, Y is the number of the driving near-by vehicles 310 approaching the destination 300 and R is an average probability that the driving near-by vehicles 310 would arrive at the destination 300.

The basic equation (1) explained above may be more accurate to assign an individual probability based on more detailed V2V information from each of the near-by vehicles. For example, the detailed V2V information may be based on a heading of direction, a number of occupants, a gas level, familiarity with the destination, and so forth. In an advanced equation (2), individual probabilities of the parked near-by vehicles (Px) and individual probabilities of the driving near-by vehicles (Ry) are summed. Here, f is a number of the near-by vehicle with a unique probability. Typically, f may be 1 for a vehicle. However, it may be possible to scale up or down based on the size of the vehicle (i.e., for a bus, f may be 3). It may be also possible to consider f as the number of occupants in the near-by vehicle (i.e., actual, average, minimum, or maximum occupants).

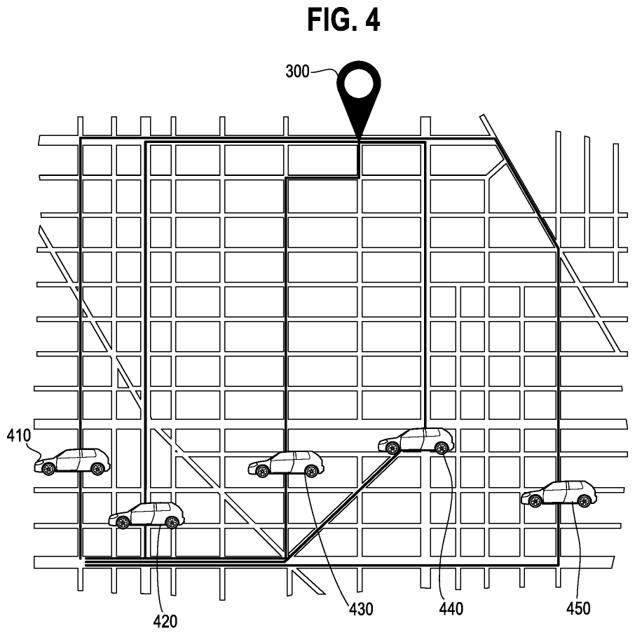

FIG. 4 is a diagram illustrating an estimation of the wait time at the destination 300 based on route factoring in some forms of the present disclosure. In FIG. 4, each of the near-by vehicles 410, 420, 430, 440, 450 is taking a different route to the destination 300. When calculating the estimated number of the target vehicles in accordance with S260, the GPS navigation unit 120 in the vehicle 100 may identify popular routes to arrive at the destination 300. For example, a low probability of going to the destination 300 may be given to the near-by vehicles 440 and 450 because the near-by vehicles 440 and 450 are taking unpopular or uncommon routes to the destination 300. These near-by vehicles 440 and 450 may be removed from consideration when calculating the estimated number of the target vehicles. Conversely, a high probability of going to the destination 300 may be given to the near-by vehicles 410, 420, and 430, respectively, if they are taking popular or common routes to the destination 300. This way of calculating the estimated wait time by reducing the number of near-by vehicles may be called a route factoring and it may help to calculate the estimated wait time at the destination 300.

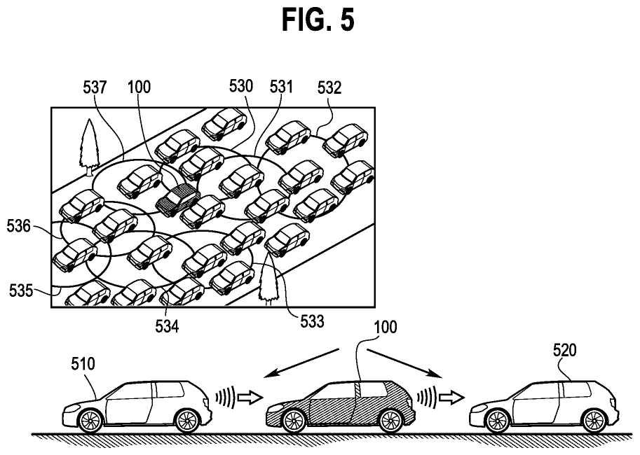

FIG. 5 is a diagram illustrating an estimation of the wait time at the destination 300 based on mesh network communication between vehicles in some forms of the present disclosure. In FIG. 5, estimating the wait time using a mesh network communication is provided. Other vehicles 510 and 520 in FIG. 5 communicate along nodes 530, 531, 532, 533, 534, 535, 536, 537, respectively, instead of using a direct V2V communication. The vehicle 100 may receive other vehicle 510 and 520's information through the cloud communication device, mobile phones, or communication infrastructure (i.e., highway cameras). This way of communication would extend the range of communication, especially for DRSC-based communicator systems that are normally limited to a 300 m range.

The method and system for estimating the wait time at the destination of the vehicle using the V2V communication described herein may be more accurate, compared to conventional technologies using historic records, to estimate the wait time because the prediction is based on real-time V2V data or information. In addition, the amount of information obtainable from the V2V communication may be increased even more when more vehicles install the V2V communication devices.

The wait time estimate feature using the V2V communication may help drivers to see their total travel time from a starting point to an ending point. It will assist them to manage their personal schedule depending on the estimated wait time. For example, the driver may change a destination if the wait time at a desired destination is shown to be higher than usual, thereby avoiding the congested area and saving time.

As the V2V communication becomes a key element in implementing a connected car as well as a self-driving car, the feature of estimating the wait time at the destination using the V2V communication is expected to be commonly used in various types of vehicles.

Some forms of the present disclosure may also be embodied as computer readable code on a computer readable recording medium. The computer readable recording medium is any data storage device that can store data which can thereafter be read by a computer system. Examples of the computer readable recording medium may include read-only memory (ROM), random-access memory (RAM), CD-ROMs, magnetic tapes, floppy disks, optical data storage devices, and carrier waves (such as data transmission over the internet).

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for estimating a wait time at a destination of a vehicle, the method comprising:
receiving, by a user interface, a request from a user to estimate the wait time at the destination of the vehicle;
determining, by a Global Positioning System (GPS) navigation unit, the destination of the vehicle, a distance from a current location of the vehicle to the destination, and an estimated arrival time of the vehicle at the destination;
collecting, by a communicator, first information from near-by vehicles using a vehicle-to-vehicle (V2V) communication, wherein the near-by vehicles are located within a predetermined distance from the destination;
calculating, by a controller, a number of target vehicles based on second information received from the near-by vehicles, wherein each of the target vehicles is expected to arrive at the destination within a predetermined time period of the estimated arrival time; and
estimating, by the controller, the wait time at the destination based on the calculated number of the target vehicles.

2. The method of claim 1, wherein the method further comprises:
displaying, by the controller, the estimated wait time at the destination on the user interface.

3. The method of claim 1, wherein the first information comprises at least one of a speed of the near-by vehicles, a direction of the near-by vehicles, a drive gear of the near-by vehicles, or a number of passengers in the near-by vehicles.

4. The method of claim 3, wherein the second information comprises at least one of a parking duration of the near-by vehicles, an operation status of the near-by vehicles, or an amount of fuel that the near-by vehicles maintain.

5. The method of claim 4, wherein calculating the number of target vehicles comprises:
determining whether the near-by vehicles are in a parking status or a driving status based on the first information; and
excluding a number of non-target vehicles from a number of near-by vehicles at least one of when the non-target vehicles are parked longer than a predetermined amount of time, when the non-target vehicles are out of operation, or when the non-target vehicles do not maintain a predetermined amount of fuel to arrive at the destination.

6. The method of claim 5, wherein calculating the number of target vehicles comprises:
calculating a first probability that the near-by vehicles in the parking status are located at the destination based on at least one of the parking duration of the near-by vehicles, an availability of a remote start of the near-by vehicles, or a proximity of key fobs.

7. The method of claim 6, wherein calculating the number of target vehicles comprises:
calculating a second probability that the near-by vehicles in the driving status arrive at the destination based on at least one of the speed of the near-by vehicles, the direction of the near-by vehicles, or navigation parameters of the near-by vehicles.

8. The method of claim 7, wherein calculating the number of target vehicles comprises:
determining a first value based on the number of near-by vehicles in the parking status and the first probability;
determining a second value based on the number of near-by vehicles in the driving status and the second probability; and
calculating the number of target vehicles by adding the first value to the second value.

9. The method of claim 8, wherein estimating the wait time at the destination comprises:
estimating the wait time at the destination based on the calculated number of target vehicles and an average time per a vehicle spent at the destination.

10. The method of claim 1, wherein collecting information from the near-by vehicles is performed by a route factoring scheme.

11. The method of claim 1, wherein collecting the information from the near-by vehicles is performed using mesh network communication.

12. A system for estimating a wait time at a destination of a vehicle, the system comprising:
a Global Positioning System (GPS) navigation unit configured to determine a route to the destination, a distance from a current location of the vehicle to the destination, and an estimated arrival time of the vehicle at the destination;
a communicator configured to:
communicate with near-by vehicles via a vehicle-to-vehicle (V2V) communication, wherein the near-by vehicles are located within a predetermined distance from the destination; and
collect information from the near-by vehicles; and
a controller configured to:
calculate a number of target vehicles based on the collected information from the near-by vehicles, wherein each of the target vehicles is expected to arrive at the destination within a predetermined time period of the estimated arrival time; and
estimate the wait time at the destination based on the calculated number of target vehicles.

13. The system of claim 12, wherein the system further comprises:
a user interface configured to:
receive, from a user, a request to estimate the wait time at the destination; and
display the estimated wait time at the destination.

14. The system of claim 12, wherein the information comprises:
a first set of the information including at least one of a speed of the near-by vehicles, a direction of the near-by vehicles, a drive gear of the near-by vehicles, or a number of passengers in the near-by vehicles; and
a second set of the information including at least one of a parking duration of the near-by vehicles, an operation status of the near-by vehicles, or an amount of fuel that the near-by vehicles maintain.

15. The system of claim 14, wherein the controller is configured to:
determine whether the near-by vehicles are in a parking status or a driving status based on the first set of the information; and
exclude a number of non-target vehicles from a number of near-by vehicles at least one of when the non-target vehicles are parked longer than a predetermined amount of time, when the non-target vehicles are out of operation, or when the non-target vehicles do not maintain a predetermined amount of fuel to arrive at the destination.

16. The system of claim 15, wherein the controller is further configured to:
calculate a first probability that the near-by vehicles in the parking status are located at the destination based on at least one of the parking duration of the near-by vehicles, an availability of a remote start of the near-by vehicles, or a proximity of key fobs.

17. The system of claim 16, wherein the controller is further configured to:
calculate a second probability that the near-by vehicles in the driving status arrive at the destination based on at least one of the speed of the near-by vehicles, the direction of the near-by vehicles, or navigation parameters of the near-by vehicles.

18. The system of claim 17, wherein the controller is further configured to:
determine a first value based on the number of near-by vehicles in the parking status and the first probability;
determine a second value based on the number of near-by vehicles in the driving status and the second probability; and
calculate the number of target vehicles by adding the first value to the second value.

19. The system of claim 18, wherein the controller is configured to:
estimate the wait time at the destination based on the calculated number of target vehicles and an average time per a vehicle spent at the destination.

20. The system of claim 12, wherein the communicator is configured to collect the information from the near-by vehicles using a route factoring scheme.

21. The system of claim 12, wherein the communicator is configured to collect the information from the near-by vehicles via mesh network communication.
